(19) United States
(12) Patent Application Publication
(10) Pub. No.: US 2003/0149944 A1
(43) Pub. Date: Aug. 7, 2003

(54) Automatic determination of inputs based on optimized dimensional management

(76) Inventor: Michael V. Reasoner, Grand Blanc, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/346,440

(22) Filed: Jan. 17, 2003

Related U.S. Application Data
(60) Provisional application No. 60/354,663, filed on Feb. 5, 2002.
(60) Provisional application No. 60/361,673, filed on Mar. 4, 2002.

(51) Int. Cl. G06F 17/50

(52) U.S. Cl. 716/1

(57) ABSTRACT

A product design process automatically identifies potential component or component assembly failure areas during the early design stages to significantly reduce costs and design time. The subject invention automatically optimizes a dimensional scheme and mathematically identifies all significant and/or critical characteristics for the component assembly. Output equations base on the optimized dimensional scheme are generated and ranges are automatically and mathematically established for each optimized output equation. The ranges represent the upper and lower worst case limits for the output equation. The equations and ranges can then be used to re-write the output equations to solve for inputs. This reformatted data can be automatically exported into a user interface to allow a user to selectively vary inputs, outputs, or dimensions to determine the potential effects on the component assembly.

### CROSS-REFERENCE TO RELATED APPLICATIONS

The application claims priority to U.S. Provisional Application No. 60/354,663, which was filed on Feb. 5, 2002 and No. 60/361,673, which was filed on Mar. 4, 2002.

### BACKGROUND OF THE INVENTION

This invention relates to a method and apparatus for streamlining component design processes by automatically identifying critical component features during the initial design stages.

Designing a new component can be a time consuming and expensive process. Even redesigning an existing component for a different application involves significant cost and time requirements. Often several design iterations are required before a component meets the minimum design requirements. Potential component areas of failure during this design process are not mathematically identified and/or automatically ranked according to order of importance. Thus, design changes made during this design iteration process are often guesses made by engineers. For example, one potential component area of failure can be affected by many different tolerance ranges called out for that specific area of the component. Should all tolerance ranges be adjusted, should only certain tolerances be changed and if so, which ones should be changed? These questions are difficult to answer.

Often, to eliminate a potential area of failure, all tolerance ranges are identified as critical and are narrowed, which significantly increases component cost and inspection time. Further, if all or some of the tolerance ranges are narrowed certain manufacturing processes might not even be able to achieve these ranges. Thus, it is desirable to have a method that identifies, in a mathematical output format, which tolerances should be changed to eliminate or reduce the affects of the potential component area of failure.

Even when a final design is achieved, this design may not be the optimal design from a material cost or inspection investment aspect. In other words, even though a design may meet all of the fit, form, and function requirements there may be additional design improvements that can be made to further reduce cost and inspection time. Currently, there is no way to easily identify or quantify these potential additional design improvements.

Also, once a component has been designed according to certain input parameters, if is often difficult and time consuming to adjust the component design in response to revised input parameter. Input parameters, such as available packaging space and/or general fit, form, and function requirements, are typically generally defined at the beginning of the design process. Design specifics are then determined based on these input parameters. Often the initial input parameters are changed during the design process. Changing an input parameter in mid-design can often result in a significant portion of the design work having to be re-done, which increases design time and cost.

Also, once a component has been designed to a certain form, fit, and function based on a certain set of input parameters, it is sometimes desirable to use this same basic component design in a different application. For example, for one product application, a certain component assembly is designed to have an overall length of 500 millimeters to fit in a specified packaging space. A similar application may be limited to an overall length of 400 millimeters. It would be desirable to use this same basic component design with dimensional modifications to satisfy the 400 millimeter overall length. Traditionally, even a small change in overall length could result in a significant amount of re-design time. Often engineers or designers simply guess at which dimensions should be modified, which introduces uncertainty whether or not critical features have been modified in such a way as to increase potential areas of component failure.

It would be desirable to provide a method and apparatus that automatically optimizes component design to produce the most cost efficient component and which can be used to easily accommodate changes in input parameters without requiring re-design. The method and apparatus should provide a design process that automatically solves for inputs based on outputs optimized during the design process, as well as overcoming the other above mentioned deficiencies with the prior art.

### SUMMARY OF THE INVENTION

The subject invention relates to a method for automatically determining product inputs by optimizing dimensional management in a component or component assembly design process. An initial list of input parameters for the component or component assembly is predetermined. An initial dimensional designation based on the input parameters, and which includes a plurality of initial dimensional tolerances defined as dimensional inputs, is then generated for the component assembly. The dimensional inputs are mathematically identified as being either significant or critical characteristics, or are identified as being neither significant nor critical characteristics. The dimensional inputs are then automatically optimized based on this identification of significant or critical characteristics.

In once disclosed embodiment, a plurality of outputs are determined based on the dimensional inputs. The subject invention then automatically assigns an occurrence level to each of the outputs.

Each of the outputs is preferably represented by an equation that includes at least one of the dimensional inputs. These equations are automatically optimized subsequent to optimization of the dimensional inputs to produce a set of optimized output equations. A range is mathematically established for each of the equations in the set of optimized output equations. Each range includes an upper worst case design limit and a lower worst case design limit for each of the equations. The subject invention automatically establishes this range for each of the equations in the set of optimized equations.

If at least one of the input parameters is modified subsequent to optimization of the dimensional inputs the subject invention automatically resolves any output equation affected by modification of the input parameter to generate at least one corresponding modified dimensional input. Thus, this modified dimensional input is already optimized based the method described above. Within this process the optimized output equations and associated range can be automatically re-written to solve for an input. These rewritten equations can be automatically exported to a window based program where a user can selectively enter modified variables to solve for a revised set of inputs. Thus, a new set of inputs can automatically be generated without have to revisit the entire design process. This results in a significant time and cost savings for the design process.

The disclosed process also works when one of the dimensional inputs is modified subsequent to optimization. The any output equation affected by modification of the dimensional input is then automatically resolved to generate at least one corresponding modified dimensional parameter.

In one disclosed embodiment, the revised set of inputs is linked to a computer aided drafting (CAD) system. The CAD system is then used to automatically generate and display a pictorial representation of the component.

Preferably, the method for automatically determining component inputs by optimizing dimensional management in a design process includes the following steps. A set of output equations is generated to define fit, form, and function characteristics for a component. A best dimensioning scheme is automatically determined based on the output equations. A set of modifiable inputs is then defined and nominal limits are determined for each output equations. A plurality of initial nominal inputs is determined based the output equations and all nominal inputs are associated with at least one output equation. A value of at least one of the modifiable inputs is modified, and a revised set of nominal inputs is automatically determined based on the modification.

The subject invention provides a method for optimizing the design process by mathematically identifying critical and significant characteristics as well as providing automatic generation of modified inputs in response to varying input parameters or dimensional designations. These and other features of the present invention can be best understood from the following specifications and drawings, the following of which is a brief description.

### BRIEF DESCRIPTION OF THE DRAWINGS

FIG. 1 is a perspective view, partially cut away, of an exemplary component designed according to the subject invention.

FIG. 2 is a cross-sectional view of the component shown in FIG. 1 including a dimensional tolerance designation.

FIG. 3 is an example of an occurrence table.

FIG. 4 is an example of a design for failure mode and effects analysis (DFMEA) output generated by the subject invention.

FIG. 5 is an example of a table defining severity evaluation criteria.

FIG. 6 is a flowchart for the subject inventive method.

FIG. 7 is a schematic representation of a computer display incorporating the subject invention.

FIG. 8 is a schematic representation of a CAD display incorporating the subject invention.

### DETAILED DESCRIPTION OF A PREFERRED EMBODIMENT

The subject invention is directed toward a method for automatically determining product inputs by optimizing dimensional management a design process. The subject invention relates to the method and apparatus for dimensional design management disclosed in co-pending application Ser. No. 10/177,275 filed on Jun. 21, 2002 and herein incorporated by reference.

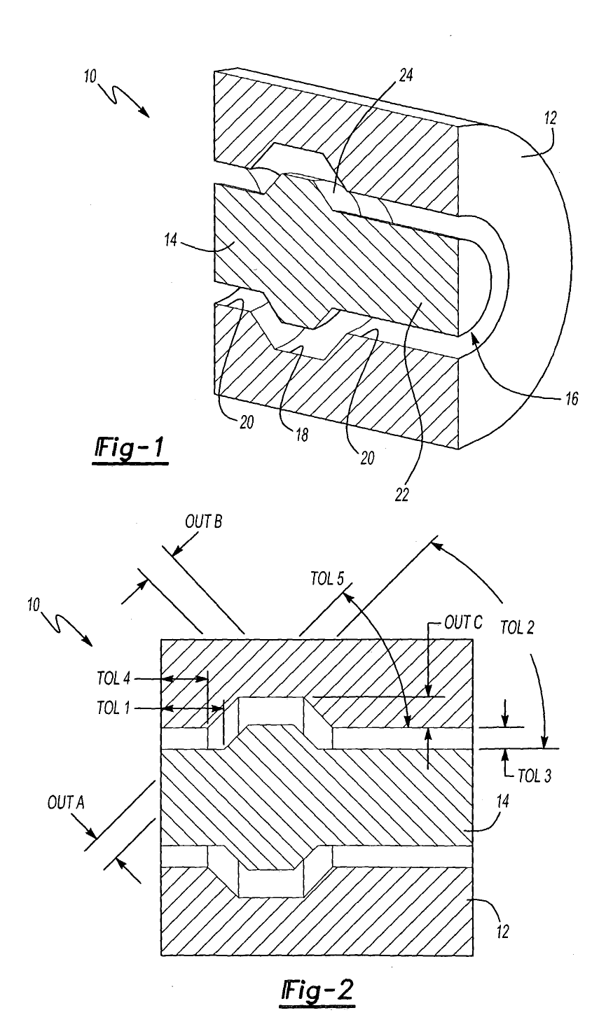

An example of a component assembly that is designed according to the subject invention is shown in FIG. 1. It should be understood that this assembly, as shown in FIG. 1, is simply one example of a component that could be designed according to the subject invention, as the subject inventive design process could be used to design any mechanical, electrical, or electromechanical component or could be used for civil engineering projects. Further, it should be understood that the subject inventive design process could be used to design a single component having component outputs specific to the component or could be used to design a component assembly or sub-assembly having component outputs specific to individual components in the assembly and/or component outputs specific to the overall assembly.

The component assembly of FIG. 1 shows a retaining mechanism 10 including a housing 12 and retaining pin 14. The housing 12 includes a central bore 16 that receives the pin 14. The bore 16 includes an increased diameter portion 18 that transitions to narrower diameter portions 20 on either side of the increased diameter portion 18. The retaining pin 14 includes a longitudinal body 22 with a resilient center flange portion 24 extending out radially from the body 22. As the retaining pin 14 is pushed into the bore 16, the flange portion 24 snaps into the increased diameter portion 18 such that the pin 14 cannot be easily withdrawn from the bore 16.

An initial dimensioning tolerance scheme for the retaining mechanism 10 is shown in FIG. 2. The initial dimensioning tolerance scheme includes a plurality of initial dimensional tolerances TOL1, TOL2, TOL3, TOL4, TOL5 that are defined as inputs. When a component, such as the retaining mechanism 10, is to be designed or redesigned there are basic rules that are required. Rules can vary according to design requirements and needs and are tied to the inputs. These rules preferably include contribution, sensitivity, occurrence and severity evaluations. These rules are used to define significant characteristics (SCs) and critical characteristics (CCs) for inputs. These SCs and CCs are linked to the production world for inspection procedures, manpower planning, and level of risk evaluations.

Further, each SC and CC has a specific Contribution requirement and/or Sensitivity requirement that must be met. As is well known in the art, Contribution relates to tolerance and Sensitivity relates to magnitude. Preferably, to qualify as either a SC or CC predetermined Contribution and Sensitivity requirements should be met, however, it should be understood that qualification as a SC or CC could involve simply meeting one of a Contribution or Sensitivity requirement. The discussion below describes SCs and CCs that must meet both Contribution and Sensitivity requirements simply as one example.

These Contribution and Sensitivity requirements are statistical evaluations and are defined by ranges or limits. To qualify as an SC for a dimension “x” identified by one of the rules, an example set of criteria may include the following: a Contribution of 60% >x>30%; a Sensitivity of 0.6>x>0.3; and a defective parts per million (DDPM)>1000. To qualify as a CC for dimension “x,” an example set of criteria may include the following: a Contribution of x>60%; a Sensitivity of x>0.6; and no DDPM requirement for qualification.

Once the list of SCs and CCs is determined, the design outputs for the component are determined for modeling. For example, if the component is a retaining mechanism, the outputs can include snap-in, engagement requirements, low lash, minimum clearance for all features, overall packaging size, etc. These outputs can be mathematically determined or graphically determined based on the various tolerances, i.e. inputs, of different dimensions of the component. These outputs can be any fit, form, or function of the component.

Preferably, the outputs are mathematically determined with equations being derived for each of the outputs based on the initial dimensioning tolerance scheme. Examples of several outputs OUTA, OUTB, OUTC are shown in FIG. 2. The equation for determining OUTA is as follows:

$$OUTA = cos ( a tan ( \frac{to11 - to14}{to13} ) - to12 ) \sqrt{{to13}^{2} + {( to11 - to14 )}^{2}}$$

Once the equations are determined and entered into the program along with the SCs and CCs requirements for the inputs, a mathematical engine generates a Contribution and a Sensitivity calculation for each input and generates a Defective Parts Per Million (DPPM) or Defective Parts Per Opportunity (DPPO) calculation for each output. These calculations are statistical determinations that are made by methods well known in the art and will not be discussed in detail. The Sensitivity and Contribution calculations are compared to the specified SC and CC rules for each of the inputs and the specified DDPM rules for each output. This comparison is then used to determine whether the input meets the definition of a SC or a CC, or to determine whether the input does not qualify for either a SC or CC.

The following example shows how this determination is made. The discussion below describes SCs and CCs that must meet both Contribution and Sensitivity requirements simply as one example, it should be understood that qualification as a SC or CC could involve simply meeting one of a Contribution or Sensitivity requirement.

Assume that the SC for a certain dimension “x” is defined by a Contribution of 60% >x>30%, a Sensitivity of 0.6>x>0.3, and a DDPM >1000. Also assume that the CC for dimension “x” is defined by a Contribution of x>60% and a Sensitivity of x>0.6. It should be understood that “x” can be any specified dimension that is related to the tolerance inputs used to determine the outputs. Also assume that OUTA, OUTB, and OUTC each include tolerances that affect the dimension “x”. The mathematical engine uses the SC, CC, and equations to generate a Contribution and Sensitivity calculation for each of the tolerances TOL1, TOL2, TOL3, TOL4, TOL5, and a DDPM calculation that affects each output equation. An example of the math modeling outputs is as follows:

OUTA

Contribution of TOL1 is 65%

Sensitivity of TOL1 is 0.7

DPPM_{(OUTA)}=1000

OUTB

Contribution of TOL3 is 40%

Sensitivity of TOL3 is 0.35

DPPM_{(OUTB)}=1000

OUTC

Contribution of TOL2 is 25%

Sensitivity of TOL2 is 0.1

DPPM_{(OUTC)}=10

Based on the SC and CC definitions above, TOL1 for OUTA would qualify as a CC because the Contribution of 65% is greater than 60% and the Sensitivity of 0.7 is greater than 0.6. TOL3 for OUTB would qualify as a SC because the Contribution of 60% is greater than 30% but less than 60%, the Sensitivity of 0.35 is greater than 0.3 but less than 0.6, and the DPPM is greater than 1000. TOL2 for OUTC would not qualify as either a SC or CC because the Contribution of 25% is less than 30%, the Sensitivity of 0.1 is less than 0.3, and the DPPM is less than 1000. Once the DPPM rule has been satisfied, then the Contribution and Sensitivity calculations are performed and reviewed to determine whether the input qualifies as a significant characteristic SC. Thus, the subject invention mathematically identifies SCs and CCs and relates this information directly back to the specific inputs.

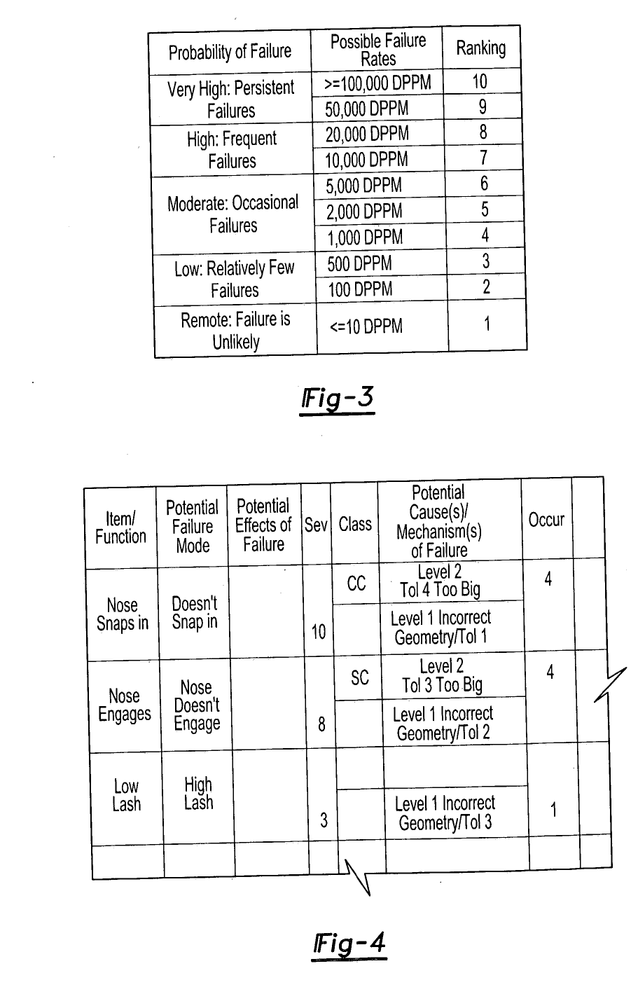

The DPPM calculation is compared to a predetermined reference chart to determine risk of failure. The reference chart is known as an Occurrence Table. An example of such a table is shown in FIG. 3. Each calculated DPPM number is compared to the table and is assigned a degree of risk. Referring to the example above, for OUTA the DPPM of 1000 is assigned a risk of 4, which indicates that failures would be occasional. The same degree of risk would also be assigned to OUTB. OUTC with a DPPM of 10 is assigned a risk of 1, which indicates that failures would be unlikely.

The subject invention then automatically exports the SCs and CCs for each input and the DDPMs for each output into a Design for Failure Mode and Effects Analysis (DFMEA) output comprising a predetermined format. Preferably, this output is generated as an output table that identifies the potential cause(s)/mechanism(s) of failure for each input associated with each output. The table preferably includes the following columns: (1) Item/Function; (2) Potential Failure Mode; (3) Potential Effects of Failure; (4) Severity; (5) Class; (6) Potential Causes/Mechanisms of Failure; and (7) Occurrence. An example of this table output format is shown in FIG. 4. It should be understood that this is just one preferred version of the table format and that the table could include fewer or more columns of information as determined by user requirements. It should also be understood that several of the columns indicated above are user defined so the number and description of columns could vary depending upon the user. Further, while an output table format is preferred, the output could be in the form of an output file that could be imported into any desired software program. The output file would include data similar to that described above.

In a typical DFMEA table output format, the Item/Function column lists the outputs in rows, e.g. snap-in, nose engages, low lash, etc. The Potential Failure Mode column is typically user defined in the initial software and lists potential failures relating to the outputs, e.g. does not snap in, nose does not engage, high lash etc. While the Potential Failure mode is typically user defined it can be optionally generated automatically.

The Potential Effects of Failure is preferably user defined and includes the result of the potential failures, e.g., component fails to operate, component noise due to vibration etc. The Potential Effects of Failure is preferably a user defined table that is incorporated into the software.

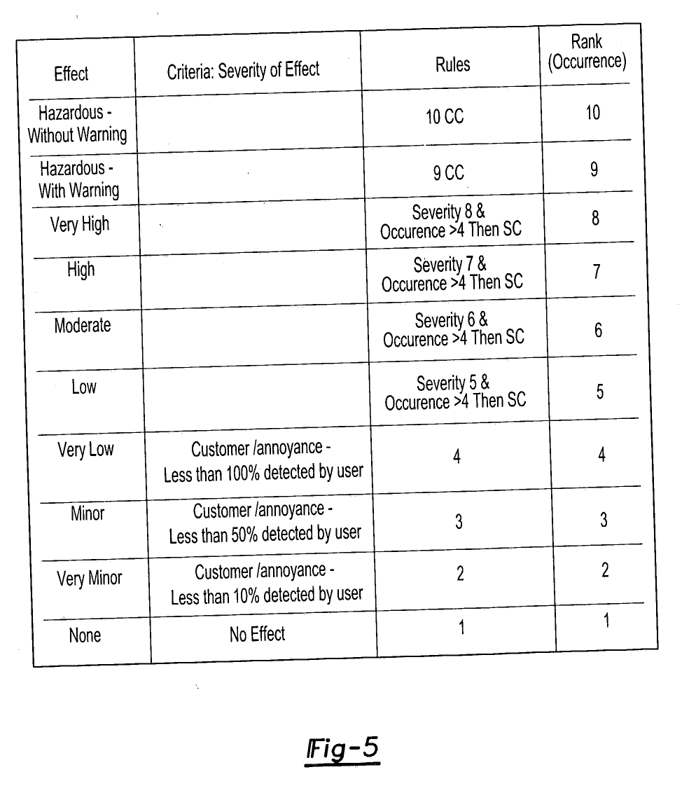

A Severity table is also defined within the software and includes a ranking system use to assign a severity ranking to the outputs. An example of a Severity Evaluation Criteria table is shown in FIG. 5. A severity ranking for each output is generated based on occurrence (generated by the DDPM evaluation for each output) to further identify significant characteristics. Critical characteristics typically are not identified/weighted by an occurrence evaluation, however, occurrence is used to mathematically identify significant characteristics by criteria including a contribution with sensitivity weighted by occurrence. In other words, a critical characteristic automatically is assigned a high severity ranking while the severity ranking of a significant characteristic is determined based on occurrence.

An example of some of the user defined columns in table of FIG. 5 include “Effects” and “Criteria: Severity of Effect.” The severity rules to determine the level of severity and to identify significant characteristics are shown in the “Rules” column and the severity ranking, as determined by the DPPM occurrence, is shown in the “Rank” column. For example, if the severity is 7 and the occurrence is greater than 4, then the input is identified as an SC, assuming any Contribution and Sensitivity requirements that may apply have also been met. The severity ranking of 7 is described as having a “High” effect. CCs typically do not need to meet an occurrence requirement. If CC requirements are met, then based on the table of FIG. 5, the associated output would automatically be assigned a 9 or 10 ranking in severity. The severity ranking of the SCs are weighted by the occurrence as shown in the “Very High” to “Low” range in the table. Thus, each output having SC identified inputs is given a severity ranking based on certain Contribution, Sensitivity, and occurrence requirements.

The Class column shows the designation of CC, SC, or neither SC nor CC, i.e. blank, for each input associated with each output. The Occurrence column is a failure/severity ranking that is determined from the DPPM and reference table as described above.

As described above, the subject invention identifies which inputs are SCs (weighted by occurrence as determined from DDPMs) and CCs, automatically associates a probability of failure occurrence ranking with each output, automatically determines which inputs are the most influential to the outputs, and automatically exports these results into the desired DFMEA table format. The Potential Causes/Mechanisms of Failure column includes the listing of the most influential inputs associated with each of the outputs. The determination of which inputs are influential is based on which inputs are identified as SCs and CCs and what the associated occurrence rank is. The subject invention has the option of listing every input associated with every output in the Potential Causes/Mechanisms of Failure column, however, to minimize the output to the DFMEA table the subject invention preferably determines which inputs are most influential to each output and only lists the inputs in the DFMEA table that have the most influence on the associated output, including all CCs and using the DPPM as the distinguishing factor for the SCs.

The subject invention further automatically assigns a predetermined cause of failure level to each of the inputs listed in the Potential Causes/Mechanisms of Failure column. An example of one predetermined cause of failure level identification system uses two levels to identify the inputs that may require tolerance changes and assigns a Level 2 or Level 1 designation. The requirements that define when a Level 2 or Level 1 designation is appropriate are predefined and can vary depending upon the component and the type of application the component or component assembly is being used in.

For example, in the DFMEA table shown in FIG. 4, the most influential input for the nose snap-in output is TOL4, which has been determined to be a CC with an occurrence ranking of 4. Further, TOL4 has been designated as a Level 2. Another input that affects the nose snap-in output is TOL1, which is designated as a Level 1 and does not qualify as either a CC or SC. Also since the output has a low occurrence ranking and no input qualified for SC or CC, the subject invention can optionally not list this input as an influential input since the occurrence value in conjunction with contribution and/or sensitivity do not satisfy the given rules.

For every tolerance/dimension input that is in an output equation, a SC/CC identifier will be assessed for qualification, an occurrence ranking will be assigned for the output, a Level 1 or 2 designation will be assigned, and a severity value will be assessed for the output based on the SC/CC/occurrence evaluations. Not every Level 1 or 2 will be designated as a CC or SC and not every input will necessarily be shown for each output. As described above, while the subject invention does determine the SC, CC, DPPM and associated severity value, and predetermined cause of failure level, not all of this information is necessarily shown in the DFMEA output table. To reduce the number of rows displayed in the table, the subject invention automatically identifies which inputs are the most influential for each output. There may be two influential inputs, ten influential inputs, or only one influential input for any one of the, outputs. Thus, the number of rows listing inputs associated with an output may vary for each output, i.e. nose snap-in may have three rows while lash may only have one row.

Thus, the subject invention automatically ties occurrence of output to the SC and CC inputs and to severity, which makes it easy to determine which dimension/tolerances inputs could be revised to reduce the occurrences. For example, because TOL4 was identified as a CC with an overall occurrence of 4 for the nose snap-in output, to reduce the occurrence TOL4 can be changed, the component can be selectively re-dimensioned, the output spec can be increased, or a design change may be implemented to possibly reduce the occurrence level associated with nose snap-in. If a simple change is made, i.e. TOL4 is made tighter, then the same nose snap-in output equation is used. The mathematical engine re-calculates, automatically identifies the influential inputs, and automatically exports this information to the DFMEA table output or into an output file for importation into a desired software program. If a more complicated change is made, i.e. the component is re-dimensioned or changed, then the equations for the output equations may have to be re-determined based on the new dimensioning scheme. Once this is done, the mathematical engine re-calculates, automatically identifies the influential inputs, and automatically exports this information to the DFMEA table output or into an output file for importation into a desired software program. Based on the information supplied in the DFMEA, the component design can be optimized to reduce cost.

Thus, the subject invention optimizes specifications and dimensioning schemes to achieve the least amount of variation for a component or component assembly design and documents this through the DFMEA. The information generated during the design optimization process can also be used to create template drawings in addition to identifying CCs and SCs in relation to the specific dimensioning scheme.

In the past, SCs and CCs were randomly selected based on historical data, personal experience, etc. These arbitrary designations of SC and CC for multiple inputs in a component or component assembly resulted in increased manufacturing costs and time/cost for inspection. To be able to mathematically identify which dimension inputs are actually SCs and CCs is a huge cost savings. To further be able to automatically associate each input with a risk associated to the outputs (i.e. occurrence) and to automatically generate a DFMEA output table incorporating this information significantly reduces design time while also providing a more accurate DFMEA based upon mathematical principles which is used by manufacturing to generate a more robust process and safer assembly procedures.

Predetermined input parameters, such as available packaging space and/or general fit, form, and function requirements, are specified for a component. Designers and engineers then determine the design specifics for the component based on these input parameters. Once the supplier has gone through the process described above, the input parameters can be easily accommodated and can be changed/varied to accommodate similar components for similar applications. The information such as the optimized output equations, occurrence levels, and optimized dimensions can then be exported into a window-based program to solve for the inputs. Inputs are user identified and can include inputs such as bolthole diameter, overall component length, etc. Then certain dimensions or input parameters can be selectively modified to determine the effect on the inputs. Or, optionally, the inputs can be selectively modified to determine the effect on the inputs.

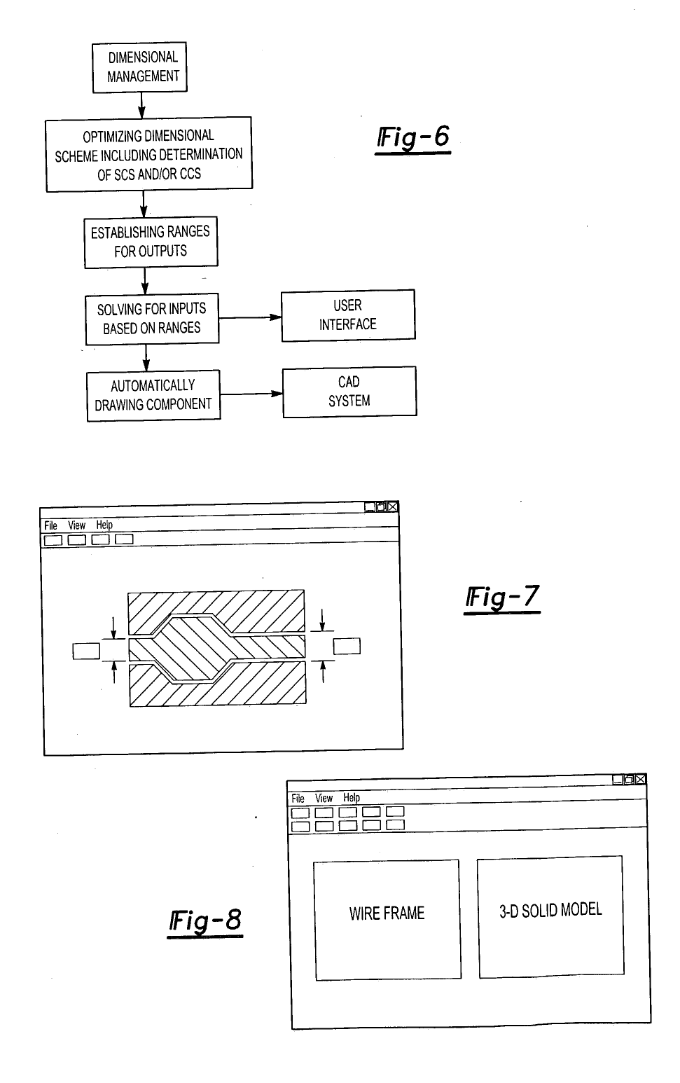

The dimensional management process is outlined in FIG. 6. As discussed above, the dimensional scheme is optimized and any SCs or CCs are identified. Then, for each output, a range is determined based on the TOL ranges for each tolerance/dimension used in the equation for that output. Thus, the ranges are determined mathematically based on the equations that were optimized during the process described above. The range establishes the upper and lower worst case limits. Once the range is determined, then the equations can be re-written to solve for the inputs.

Example: A component has been designed according to the above process and the overall length was 500 mm. Now the user wants the same component but wants the component to be 600 mm in overall length. The equations can be automatically recalculated with an overall length of 600 mm to identify potential causes/mechanisms of failure.

In the past, the ranges were determined by guessing, which could result in a combination of equations that may not have a solution. The subject invention automatically and mathematically establishes the ranges to result in a combination of equations that can be re-written to solve for the inputs. These equations and ranges can be incorporated into a user interface such as a windows based program, shown in FIG. 7, where a user can selectively modify dimensions, inputs, or outputs to determine overall effect on potential risks of failure.

Further, once the dimensions of the component have been optimized, the data can be exported into a computer aided drafting (CAD) based drawing program to automatically draw the component. The component can be drawn in three-dimensional solid modeling format or wireframe format. The operation of CAD systems is well know and will not be discussed in detail.

The method for automating inputs includes the following steps. All fit, form, and function equations, i.e., the output equations including output and input variables with the best dimensioning scheme determined, should be generated according to the process described above. This best dimensioning scheme should then be applied to a print, i.e. engineering drawing, of the component. The best dimensioning scheme is determined through the least variation added to the fit, form, and function equations, which is determined and verified as the equations are being written according to the process detailed above.

Next, users need to define a set of modifiable inputs that will drive automation. These modifiable inputs are inputs that can be changed or varied such as hole size or component thickness, for example, to accommodate an increase/decrease in component size for light/heavy duty applications, respectively, or to accommodate changes in overall packaging size. Then, based on engineering experience, successful “nominal” limits should be determined for each nominal fit, form, and function equation, i.e. output equation. In other words, from the list of output equations determined above, the user defines what “nominal” is the desired value for the specific output equation. The estimated nominal ranges are then automatically established for the output equations with the “nominal” value preferably being at the center of the range.

Once the nominal limits or ranges are applied, the user must proceed with the following steps. First, the user should determine what nominal output limits can be met at one time (simultaneous equations). If all of the nominal output limits cannot be met with simultaneous equations, then the user must determine which nominal output limits can be shifted to allow for the simultaneous equations to be solved. Second, the user should determine how many nominal inputs are still undefined due to lack of equations, i.e., how many nominal inputs are undefined because there are not enough equations to solve for all of the nominal inputs. Third, based on previous engineering experiences and experiences with successful component/assembly relationships, the user must establish geometric relationships between the nominal inputs until each undefined nominal input can be defined through the equations. The program will automatically prompt the user to enter these specific relationships. It should be understood that these relationships are additional output equations that are needed to solve for the remaining unidentified nominal inputs but were not necessarily identified in the output equation process explained above. These additional output equations are referred to here as geometric relationships simply for identification purposes.

With any realistic changes to the defined modifiable inputs, all nominal input dimensions can now be automated once the steps described above have been successfully performed. The user must then add tolerances to each of the automated nominal values and run the fit, form, and function calculations to determine acceptable tolerances for each value.

Although a preferred embodiment of this invention has been disclosed, a worker of ordinary skill in this art would recognize that certain modifications would come within the scope of this invention. For that reason, the following claims should be studied to determine the true scope and content of this invention.

1. A method for automatically determining component inputs by optimizing dimensional management in a design process comprising the steps of:
(a) generating a set of output equations to define fit, form, and function characteristics for a component;
(b) automatically determining a best dimensioning scheme based on the equations of step (a);
(c) defining a set of modifiable inputs;
(d) determining nominal limits for each output equation;
(e) determining a plurality of initial nominal inputs based the output equations;
(f) associating all nominal inputs with at least one output equation;
(g) changing a value of at least one of the modifiable inputs; and
(h) automatically determining a revised set of nominal inputs based on the change made in step (g).

2. A method as set forth in claim 1 wherein the modifiable inputs of step (c) are user defined.

3. A method as set forth in claim 2 wherein step (c) further includes defining a component by generating a plurality of initial inputs based on component size, packaging constraints, or component application and subsequently determining which of the initial inputs can be varied to define one of the modifiable inputs.

4. A method as set forth in claim 1 wherein the nominal limits of step (d) are desired output values that are user defined.

5. A method as set forth in claim 4 wherein step (d) further includes automatically generating a nominal range for each output equations based on each respective nominal limit.

6. A method as set forth in claim 5 wherein the nominal limit is approximately at a center of the nominal range.

7. A method as set forth in claim 1 including the step of determining which nominal limits for the output equations can be solved at one time with simultaneous equations.

8. A method as set forth in claim 7 including the step of determining which nominal limits can be modified to allow for simultaneous equation solution if simultaneous equations cannot be used initially to solve for all nominal limits.

9. A method as set forth in claim 8 including the step of identifying any nominal inputs that are undefined due to lack of equations.

10. A method as set forth in claim 9 including the step of assigning at least one geometric relationship to each undefined nominal input until each undefined nominal input can be defined through a combination of output equations and geometric relationships.

11. A method as set forth in claim 1 including the step of adding initial tolerances to each revised nominal input, calculating the associated fit, form, and function characteristics, and automatically determining acceptable tolerance ranges for each revised nominal input.

12. A method for automatically determining product inputs by optimizing dimensional management in a component or component assembly design process comprising the steps of:
(a) providing an initial list of input parameters for the component;
(b) generating an initial dimensional designation based on the input parameters including a plurality of initial dimensional tolerances defined as dimensional inputs;
(c) mathematically identifying which of the dimensional inputs are significant or critical characteristics; and
(d) automatically optimizing dimensional inputs based on identification of significant or critical characteristics.

13. A method as set forth in claim 1 including the steps of determining a plurality of outputs based on the dimensional inputs and automatically assigning an occurrence level to each of the outputs.

14. A method as set forth in claim 2 wherein each of the outputs is represented by an equation including at least one of the dimensional inputs and further including the step of automatically optimizing the equations subsequent to step (d) to produce a set of optimized output equations.

15. A method as set forth in claim 3 further including the step of mathematically establishing a range for each of the equations in the set of optimized output equations.

16. A method as set forth in claim 4 wherein each range includes an upper worst case design limit and a lower worst case design limit for each of the equations.

17. A method as set forth in claim 4 including the step of automatically establishing the range for each of the equations in the set of optimized output equations.

18. A method as set forth in claim 6 further including the step of modifying at least one of the input parameters subsequent to step (d) and automatically resolving any output equation affected by modification of the input parameter to generate at least one corresponding modified dimensional input.

19. A method as set forth in claim 7 further including the step of automatically reevaluating at least one of the optimized output equations and associated range to solve for an input.

20. A method as set forth in claim 8 further including the step of automatically transferring the optimized output equations and associated ranges into a window based program to solve for a revised set of inputs.

21. A method as set forth in claim 9 further including the step of linking the revised set of inputs to a computer aided drafting system.

22. A method as set forth in claim 10 further including the step of automatically generating and displaying a pictorial representation of the component with the computer aided drafting system.

23. A method as set forth in claim 6 further including the step of modifying at least one of the dimensional inputs subsequent to step (d) and automatically resolving any output equation affected by modification of the dimensional input to generate at least one corresponding modified dimensional parameter.

24. A method as set forth in claim 2 wherein each of the outputs is graphically represented based on at least one of the dimensional inputs and further including the step of automatically optimizing a graphical representation of each output subsequent to step (d) to produce an optimized graphical output representation.

25. A method as set forth in claim 1 further including the step of automatically generating and displaying a pictorial representation of the component or component assembly subsequent to step (d).

26. A method as set forth in claim 14 wherein the pictorial representation is a three-dimensional solid model of the component or component assembly.

27. A method as set forth in claim 15 wherein the pictorial representation is a wire-frame model of the component or component assembly.

28. A method for automatically determining product inputs by optimizing dimensional management in a component or component assembly design process comprising the steps of:
(a) providing an initial list of input parameters for the component;
(b) generating an initial dimensional designation based on the input parameters including a plurality of initial dimensional tolerances defined as dimensional inputs;
(c) determining at least one output defined by an output equation including at least one of the dimensional inputs;
(d) automatically optimizing the dimensional inputs based on identification of significant or critical characteristics;
(e) automatically optimizing the output equation subsequent to step (d) to produce an optimized output equation;
(f) automatically establishing a variance range for the output equation defined by an upper worst case design limit and a lower worst case design limit;
(g) changing at least one input parameter subsequent to step (f); and
(h) automatically resolving the optimized output equation.

29. A method according to claim 17 further including the step of automatically exporting the optimized equation and associated variance range into a window based program and for selective solutions for new inputs based the optimized equation and variance range.

30. A method according to claim 17 further including the steps of exporting optimized dimensional inputs into a computer aided drafting program and automatically generating a pictorial representation of the component or component assembly.

31. A method according to claim 17 further including the step of automatically assigning an occurrence level to each of the outputs.

32. A computer readable medium storing a computer program, which when executed by a computer performs the steps of:
(a) receiving an initial list of input parameters for the component;
(b) generating an initial dimensional designation based on the input parameters including a plurality of initial dimensional tolerances defined as dimensional inputs;
(c) mathematically identifying which of the dimensional inputs are significant or critical characteristics; and
(d) automatically optimizing dimensional inputs based on identification of significant or critical characteristics.

33. The computer readable medium of claim 21, which when executed by the computer performs the additional steps of:
determining a plurality of outputs based on the dimensional inputs and automatically assigning an occurrence level to each of the outputs

34. The computer readable medium of claim 22 wherein each of the outputs is represented by an equation including at least one of the dimensional inputs and wherein the computer performs the additional step of automatically optimizing the equations subsequent to step (d) to produce a set of optimized output equations.

35. The computer readable medium of claim 23 which when executed by the computer performs the additional steps of:
mathematically establishing a range defined by an upper worst case design limit and a lower worst case design limit for each of the equations in the set of optimized output equations.

36. The computer readable medium of claim 24 which when executed by the computer performs the additional steps of:
automatically establishing the range for each of the equations in the set of optimized output equations.

37. The computer readable medium of claim 25 which when executed by the computer performs the additional steps of:
modifying at least one of the input parameters subsequent to step (d) and automatically resolving any output equation affected by modification of the input parameter to generate at least one corresponding modified dimensional input.

38. The computer readable medium of claim 26 which when executed by the computer performs the additional steps of:
automatically re-writing at least one of the optimized output equations and associated range to solve for an input.

39. The computer readable medium of claim 27 which when executed by the computer performs the additional steps of:
automatically transferring the optimized output equations and associated ranges into a window based program to solve for a revised set of inputs.

40. The computer readable medium of claim 28 which when executed by the computer performs the additional steps of:
exporting the dimensional inputs from the optimized output equations into a computer aided drafting program, and
automatically generating and displaying a pictorial representation of the component.

41. The computer readable medium of claim 25 which when executed by the computer performs the additional steps of:
modifying at least one of the dimensional inputs subsequent to step (d) and automatically resolving any output equation affected by modification of the dimensional input to generate at least one corresponding modified dimensional parameter.

42. The computer readable medium of claim 21 which when executed by the computer performs the additional steps of:
automatically generating and displaying a pictorial representation of the component or component assembly subsequent to step (d).

43. A computer readable medium storing a computer program, which when executed by a computer performs the steps of:
(a) providing an initial list of input parameters for the component;
(b) generating an initial dimensional designation based on the input parameters including a plurality of initial dimensional tolerances defined as dimensional inputs;
(c) determining at least one output defined by an output equation including at least one of the dimensional inputs;
(d) automatically optimizing the dimensional inputs based on identification of significant or critical characteristics;
(e) automatically optimizing the output equation subsequent to step (d) to produce an optimized output equation;
(f) automatically establishing a variance range for the output equation defined by an upper worst case design limit and a lower worst case design limit;
(g) changing at least one input parameter subsequent to step (f); and
(h) automatically resolving the optimized output equation.

44. The computer readable medium of claim 32 which when executed by the computer performs the additional steps of:
exporting optimized dimensional inputs into a computer aided drafting program and automatically generating a pictorial representation of the component or component assembly.
